(19) United States
(12) Patent Application Publication
(10) Pub. No.: US 2024/0190245 A1
(43) Pub. Date: Jun. 13, 2024

(54) SPEED DISPLAY DEVICE

(71) Applicant: Brent Diller, Pendleton, NC (US)

(72) Inventor: Brent Diller, Pendleton, NC (US)

(21) Appl. No.: 18/076,677

(22) Filed: Dec. 7, 2022

(51) Int. Cl. B60K 35/00

(52) U.S. Cl. CPC B60K 35/00; B60K 2370/16; B60K 2370/1876; B60K 2370/188; B60K 2370/334; B60K 2370/52; B60K 2370/785

(57) ABSTRACT

A speed display device connected to at least a portion of a vehicle, the speed display device including a speed sensor to detect a speed level of the vehicle, and a display unit disposed on at least a portion of the speed sensor to project the speed level of the vehicle on a window of the vehicle.

### BACKGROUND

### 1. Field

The present general inventive concept relates generally to vehicle safety, and particularly, to a speed display device.

### 2. Description of the Related Art

While operating a vehicle, a driver can determine a speed of travel of the vehicle using a speedometer. Thus, the driver will only know the speed of the vehicle, but not an exact speed of any other vehicle driving within proximity of the vehicle of the driver.

The lack of knowledge of the speed of another vehicle can make it difficult for another driver to adjust the speed of another vehicle. Specifically, the other driver may have difficulty determining whether it is safe to increase speed and/or decrease speed, which can increase the likelihood of traffic and/or collisions from sudden and/or inconsistent braking.

Therefore, there is a need for a speed display device that is connected to the vehicle to display the speed of the vehicle on a rear window to notify surrounding drivers of the speed of the vehicle.

### SUMMARY

The present general inventive concept provides a speed display device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a speed display device connected to at least a portion of a vehicle, the speed display device including a speed sensor to detect a speed level of the vehicle, and a display unit disposed on at least a portion of the speed sensor to project the speed level of the vehicle on a window of the vehicle.

The speed sensor may detect the speed level of the vehicle based on movement of the vehicle across an external surface.

The speed sensor may receive the speed level of the vehicle as input from at least one electronic system of the vehicle.

The speed display device may further include a control unit disposed on at least a portion of the speed sensor to adjust the speed level projected by the display unit using a predetermined algorithm of speed levels based on movement of the vehicle across an external surface.

The control unit may change a color projected from the display unit on the window based on a change in the speed level of the vehicle as detected by the speed sensor.

The control unit may change the display unit to project the speed level in a first color in response to determining the vehicle is increasing the speed level, and the control unit changes the display unit to project the speed level in a second color in response to determining the vehicle is decreasing the speed level.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a speed display device as disposed on a vehicle, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Speed Display Device 100
Speed Sensor 110
Projecting Unit 120
Control Unit 130

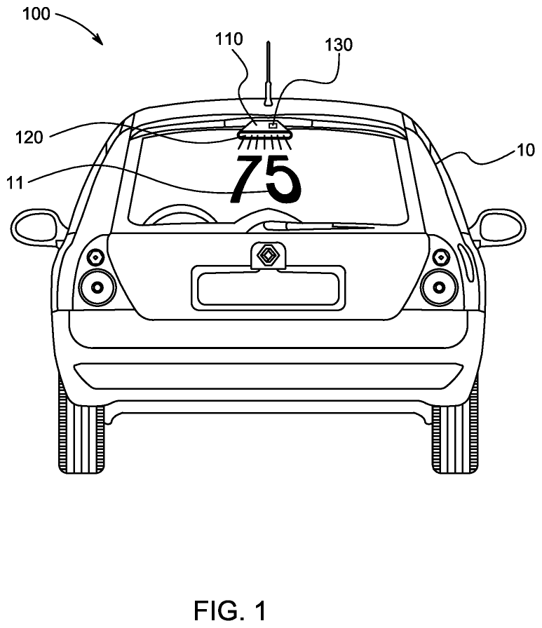

FIG. 1 illustrates a front perspective view of a speed display device 100 as disposed on a vehicle 10, according to an exemplary embodiment of the present general inventive concept.

The speed display device 100 may be constructed from at least one of metal, plastic, wood, glass, and rubber, etc., but is not limited thereto.

The speed display device 100 may include a speed sensor 110, a projecting unit 120, and a control unit 130, but is not limited thereto.

The speed sensor 110 be removably connected (e.g., screws, bolts, nails, washers, nuts, hook-and-loop fastener, adhesive (tape, glue), and/or magnet) to at least a portion of a vehicle 10. In other words, the speed sensor 110 may be retrofit to the vehicle 10. Alternatively, the speed sensor 110 may be constructed with and/or integrated into the vehicle 10.

Furthermore, the speed sensor 110 may be connected to at least one electronic system (e.g., a speedometer, a processing unit, a central processor, a microcontroller) of the vehicle 10. However, the speed sensor 110 may scan and/or detect a speed level of the vehicle 10 based on movement of the vehicle 10 across an external surface (e.g., a ground surface, a road, a street). As such, the speed sensor 110 may detect the speed level of the vehicle 10, independently, and/or without being connected to the at least one electronic system of the vehicle 10. Alternatively, the speed sensor 110 may detect the speed level of the vehicle 10 using the at least one electronic system of the vehicle 10, such that the speed sensor 110 may receive the speed level as input from the at least one electronic system of the vehicle 10.

The display unit 120 may include a projector, a plasma screen, an LCD screen, a light emitting diode (LED) screen, an organic LED (OLED) screen, a computer monitor, a hologram output unit, a sound outputting unit, or any other type of device that visually or aurally displays data.

The display unit 120 may be disposed on at least a portion of the speed sensor 110. Moreover, the display unit 120 may be oriented toward a window 11 (e.g., a rear window) of the vehicle 10. The display unit 120 may project and/or display the speed level of the vehicle 10 on the window 11. In other words, the window 11 may display the speed level of the vehicle 10 in response to receiving a projection of the speed level from the display unit 120.

Thus, another driver in another vehicle 10 following the vehicle 10 may view the speed level of the vehicle 10 to adjust a speed level of the another vehicle 10. Thus, the speed sensor 110 and/or the display unit 120 may improve safety during driving by notifying the another driver of the speed level of the vehicle 10, such that the another driver may decrease and/or increase the speed level of the another vehicle 10 accordingly.

The control unit 130 may include a processing unit, a communication unit, and a storage unit, but is not limited thereto.

The processing unit of the control unit 130 (or central processing unit, CPU) may include electronic circuitry to carry out instructions of a computer program by performing basic arithmetic, logical, control and input/output (I/O) operations specified by the instructions. The processing unit of the control unit 130 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 130 may also include a microprocessor and a microcontroller.

The communication unit of the control unit 130 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit of the control unit 130 may include a random access memory (RAM), a read-only memory (ROM), a hard disk, a flash drive, a database connected to the Internet, cloud-based storage, Internet-based storage, or any other type of storage unit.

The control unit 130 may be disposed on and/or within at least a portion of the speed sensor 110. The control unit 130 may access the Internet via the communication unit to allow the user to access a website, and/or may allow a software application to be executed using the processing unit. For ease of description, the software application will be hereinafter referred to as an app. The app may be downloaded from the Internet to be stored on the storage unit.

The control unit 130 executing the app may receive the speed level from the speed sensor 110 to determine whether the speed level is accurate. More specifically, the control unit 130 may receive data from the speed sensor 110 to compare the speed level to a predetermined algorithm of speed levels based on movement across the external surface. As such, the control unit 130 may adjust the speed level projected and/or displayed by the display unit 120.

Also, the control unit 130 may change a color emitted and/or projected from the display unit 120 on the window 11 based on a change in the speed level as detected by the speed sensor 110. For example, the control unit 130 may change the display unit 120 to project the speed level in a first color (e.g., green) in response to determining the vehicle 10 is increasing the speed level. Conversely, the control unit 130 may change the display unit 120 to project the speed level in a second color (e.g., orange, red) in response to determining the vehicle 10 is decreasing the speed level.

Therefore, the speed display device 100 may notify the another driver of the another vehicle 10 of the speed level of the vehicle 10, such that traffic and/or collisions may be reduced. As such, the speed display device 100 may improve safety during driving and create a more relaxed driving experience.

The present general inventive concept may include a speed display device 100 connected to at least a portion of a vehicle 10, the speed display device 100 including a speed sensor 110 to detect a speed level of the vehicle 10, and a display unit 120 disposed on at least a portion of the speed sensor 110 to project the speed level of the vehicle 10 on a window 11 of the vehicle 10.

The speed sensor 120 may detect the speed level of the vehicle 10 based on movement of the vehicle 10 across an external surface.

The speed sensor 120 may receive the speed level of the vehicle 10 as input from at least one electronic system of the vehicle 10.

The speed display device 100 may further include a control unit 130 disposed on at least a portion of the speed sensor 110 to adjust the speed level projected by the display unit 120 using a predetermined algorithm of speed levels based on movement of the vehicle 10 across an external surface.

The control unit 130 may change a color projected from the display unit 120 on the window 11 based on a change in the speed level of the vehicle 10 as detected by the speed sensor 110.

The control unit 130 may change the display unit 120 to project the speed level in a first color in response to determining the vehicle 10 is increasing the speed level, and the control unit 130 changes the display unit 120 to project the speed level in a second color in response to determining the vehicle 10 is decreasing the speed level.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A speed display device connected to at least a portion of a vehicle, the speed display device comprising:
a speed sensor to detect a speed level of the vehicle; and
a display unit disposed on at least a portion of the speed sensor to project the speed level of the vehicle on a window of the vehicle.

2. The speed display device of claim 1, wherein the speed sensor detects the speed level of the vehicle based on movement of the vehicle across an external surface.

3. The speed display device of claim 1, wherein the speed sensor receives the speed level of the vehicle as input from at least one electronic system of the vehicle.

4. The speed display device of claim 1, further comprising:
a control unit disposed on at least a portion of the speed sensor to adjust the speed level projected by the display unit using a predetermined algorithm of speed levels based on movement of the vehicle 10 across an external surface.

5. The speed display device of claim 4, wherein the control unit changes a color projected from the display unit on the window based on a change in the speed level of the vehicle as detected by the speed sensor.

6. The speed display device of claim 4, wherein the control unit changes the display unit to project the speed level in a first color in response to determining the vehicle is increasing the speed level, and the control unit changes the display unit to project the speed level in a second color in response to determining the vehicle is decreasing the speed level.
